(19) United States
(12) Patent Application Publication
(10) Pub. No.: US 2012/0074083 A1
(43) Pub. Date: Mar. 29, 2012

(54) Rack for sports equipment

(76) Inventor: Geoffrey S. Geils, New Fairfield, CT (US)

(21) Appl. No.: 12/924,309

(22) Filed: Sep. 24, 2010

(51) Int. Cl. A47F 7/00; F16M 11/04; F16M 13/02; F16B 47/00; F16B 2/20; F16M 11/24

(52) U.S. Cl. 211/85.7; 211/60.1; 248/231.81; 248/206.2; 248/125.8

(57) ABSTRACT

A device is provided for retaining an elongated article including two oppositely oriented arcuate members. The device also includes a member extending between and connecting the arcuate members, and an arrangement mounted on each of the arcuate members for releasably engaging the article. The device further includes an arrangement associated with each of the arcuate members for mounting the arcuate members on a surface. The elongated article may include a piece of sporting equipment. A retaining device is provided that includes a frame including two arcuate members connected by a cross member. Each arcuate member is oriented opposite to the other arcuate member. The retaining device also includes at least one clip mounted on the frame and adapted to releasably engage an elongated article. The retaining device further includes a mounting arrangement connected to the frame and adapted to attach the frame to a surface.

### CROSS-REFERENCE TO RELATED APPLICATIONS

This application claims the benefit of U.S. Design patent application No. 29/348,042 filed Feb. 23, 2010 under 35 U.S.C. Sec. 120, which is incorporated herein by reference.

### STATEMENT REGARDING FEDERALLY SPONSORED RESEARCH OR DEVELOPMENT

Not Applicable

### BACKGROUND OF THE INVENTION

1. Field of the Invention

The present invention relates to sports equipment, and in particular relates to a rack for holding sports equipment.

2. Description of Prior Art

Lacrosse (lax) sticks have been stored in an ad hoc manner, in a place that is not easily accessible or attractive. Lacrosse sticks may be stored in boxes or on shelves. Lacrosse sticks stored in boxes, shelves, or leaning against a wall may become dislodged and be a hazard, become damaged, and/or occupy an inordinate amount of space.

### BRIEF SUMMARY OF THE INVENTION

An exemplary embodiment enables lacrosse players to hang and display their sticks in their cars and in their rooms in an orderly and secure fashion.

A device is provided for retaining an elongated article including two oppositely oriented arcuate members. A member extends between and connecting the arcuate members and an arrangement mounts on each of the arcuate members for releasably engaging the article. The device further includes an arrangement associated with the arcuate members for mounting the arcuate members on a surface.

The elongated article may include, for example, a lacrosse stick, a hockey stick baseball bat, golf club and/or a field hockey stick. Concave edges of the two oppositely oriented arcuate members may face each other, and the member may be substantially linear and connect centers of the concave edges.

The arrangement for releasably engaging the article may include spring-loaded clips able to releasably engage the elongated article. The clips may be rotatable with respect to the arcuate members. The arrangement for releasably engaging the article may include six clips, with three of the clips being mounted on each of the two arcuate members. Two of the clips on each arcuate member may be mounted near ends of the respective arcuate member and one of the clips on each arcuate member may be mounted at a center of the arcuate member.

The six clips may be arranged on the frame to hold three articles, in which two clips hold each article and the articles are parallel to the member when held by the clips. The six clips may be rotated in this arrangement on the frame to hold four articles, in which the two clips mounted near the tip of each respective arcuate member hold one of the four articles, and the one clip mounted at a center of the arc of each respective arcuate member holds one of the four articles. The articles in this case are orthogonal to the member when held by the clips.

The arrangement for mounting may include four suction cups, in which two of the four suction cups may be connected to each arcuate member. Each suction cup may include a height adjustable leg attaching each suction cup to the respective arcuate member.

The device may be adapted to releasably receive a sign. The sign may include indicia promoting a team, a school, and/or a sponsor.

In accordance with another exemplary embodiment of the present innovation, a retaining device is provided that includes a frame including two arcuate members connected by a cross member. Each arcuate member is oriented opposite to the other arcuate member. The retaining device also includes at least one clip mounted on the frame and adapted to releasably engage an elongated article. The retaining device further includes a mounting arrangement connected to the frame and adapted to attach the frame to a surface.

The mounting arrangement may include four suction cups, and the two suction cups may be connected to each arcuate member. Each suction cup may include a height adjustable leg attaching each suction cup to the respective arcuate member.

These and other advantages of the invention will be apparent to those of ordinary skill in the art by reference to the following detailed description and the accompanying drawings.

### BRIEF DESCRIPTION OF THE DRAWINGS

FIG. 1 is a perspective view of an exemplary embodiment of a sports equipment rack;

FIG. 2 is an exploded view of the exemplary sports equipment rack of FIG. 1;

FIG. 3 is a plan view of the exemplary sports equipment rack of FIG. 1;

FIG. 4 is a bottom view of the exemplary sports equipment rack of FIG. 1;

FIG. 5 is an end view of the exemplary sports equipment rack of FIG. 1; and

FIG. 6 is an end view of the exemplary sports equipment rack of FIG. 1.

### DETAILED DESCRIPTION OF THE INVENTION

An exemplary sports equipment rack holds sporting goods, for example lacrosse sticks, baseball bats, hockey sticks, baseball bat, golf club and/or field hockey sticks. The exemplary sports equipment rack may fit on automobile windows, or on building windows, on an interior or an exterior surface. The exemplary sports equipment rack may be used with wall mounts for mounting on walls or doors. The rack may use suction cups or wall fixtures for mounting. The rack can be mounted horizontally or vertically, and may hold three sticks horizontally, or hold four sticks vertically.

The exemplary sports equipment rack is height adjustable to fit in automobile rear windows. The legs have adjustable height which may be of particular use in the situation of mounting on the interior of a car window. Horizontally, the rack can hold three sticks, and vertically, the rack can hold four sticks. The rack itself may be oriented to the vertical or horizontal position.

The exemplary sports equipment rack may include a sign or logo plate for school stickers on a front surface and/or a back surface of the frame. The frame of the rack may include an arrangement for mounting or detachably attaching a logo, for instance of a team, school and/or sponsor. The clips may be spring loaded, and there may be areas on the frame for clipping or attaching helmets and/or balls. The exemplary sports equipment rack may be lightweight, easy to produce, easy to assemble, and be inexpensive to make.

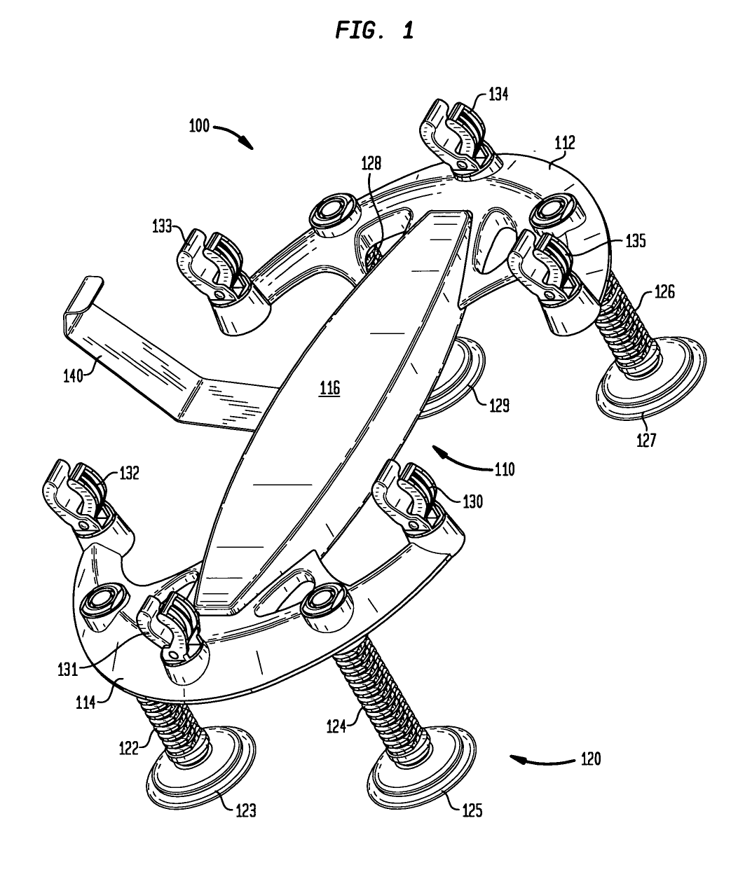

FIG. 1 is a perspective view of an exemplary embodiment of sports equipment rack 100. Sports equipment rack 100 includes frame 110 and mounting arrangement 120. Frame 110 includes two arcuate members 112, 114 connected by cross-member 116. Cross-member 116 is attached to a point on each arcuate members 112, 114 at a center of the arc defined by each arcuate member 112, 114. In FIG. 1, arcuate member 112, 114 are aligned and have convex edges and concave edges, with the concave edges facing each other. Each arcuate member 112, 114 has three clips 133, 134, 135, and 130, 131, 132, respectively. Clips 130, 131, 132, 133, 134, 135 may be releasable and rotatable, and may be spring-loaded. Clips 130, 131, 132, 133, 134, 135 are positioned on sports equipment rack 100 to cooperate and hold three elongated articles horizontally (i.e., parallel to cross-member 116), with clips 130 and 135 holding one article, clips 131 and 134 holding another article, and clips 132 and 133 holding the third article. Alternatively or additionally, clips 130, 131, 132, 133, 134, 135 may cooperate and hold four elongated articles vertically (i.e., orthogonal to cross-member 116), with clip 131 holding one article, clips 130 and 132 holding a second article, clips 133 and 135 holding a third article, and clip 134 holding a fourth article. Clips 130, 131, 132, 133, 134, 135 may be configured to hold any type of elongated article, and in particular may be designed to hold a piece of sporting equipment, for instance a lacrosse stick, a hockey stick, baseball bat, golf club, a field hockey stick, or any other item having a shaft.

Sports equipment rack 100 may include hook 140, which may be for holding a helmet or any other appropriate item. Additionally or alternatively, sports equipment rack 100 may also include an arrangement for holding a ball or puck, either in a cup or depression, or in a squeezing or pinching arrangement. Sports equipment rack 100 includes mounting arrangement 120 for attaching sports equipment rack 100 to a wall or window. Sports equipment rack 100 in FIG. 1 includes leg 122 attached to arcuate member 114 on one end and having suction cup 123 on the other end. Leg 124 is attached to arcuate member 114 on one end and has suction cup 125 on the other end. Leg 126 is attached to arcuate member 112 on one end and has suction cup 127 on the other end, and leg 128 is attached to arcuate member 112 on one end and has suction cup 129 on the other end. Legs 122, 124, 126, 128 may be adjustable providing different heights, or may be replaceable with other legs having fixed heights of a different height than legs 122, 124, 126, 128. In some situations, legs of different heights, or bent legs, may be used, for instance to attach sports equipment rack 100 to different surfaces. In still further alternatives, legs 122, 124, 126, 128 may be removed completely and suction cups 123, 125, 127, 129 may attach directly to their respective arcuate members. In further alternatives, legs may be attached to cross-member 116, and/or more or fewer legs may be used than four legs. Also, suction cups 123, 125, 127, 129 may be replaced with a wall mount or door mount arrangement that may be permanent or temporary. For instance, suction cups 123, 125, 127, 129 may be replace with brackets that can be attached to a wall with screws, or two of suction cups 123, 125, 127, 129 on one side (for instance, suction cups 123, 125; suction cups 127, 129; suction cups 125, 127; or suction cups 123, 129) may be replaced with hooks appropriate for hanging over the top of a door or other fixed top edge, while the two other suction cups remain as suction cups or as rubber caps that rest against the door or other surface and are further stabilized as weighty items are added to sports equipment rack 100.

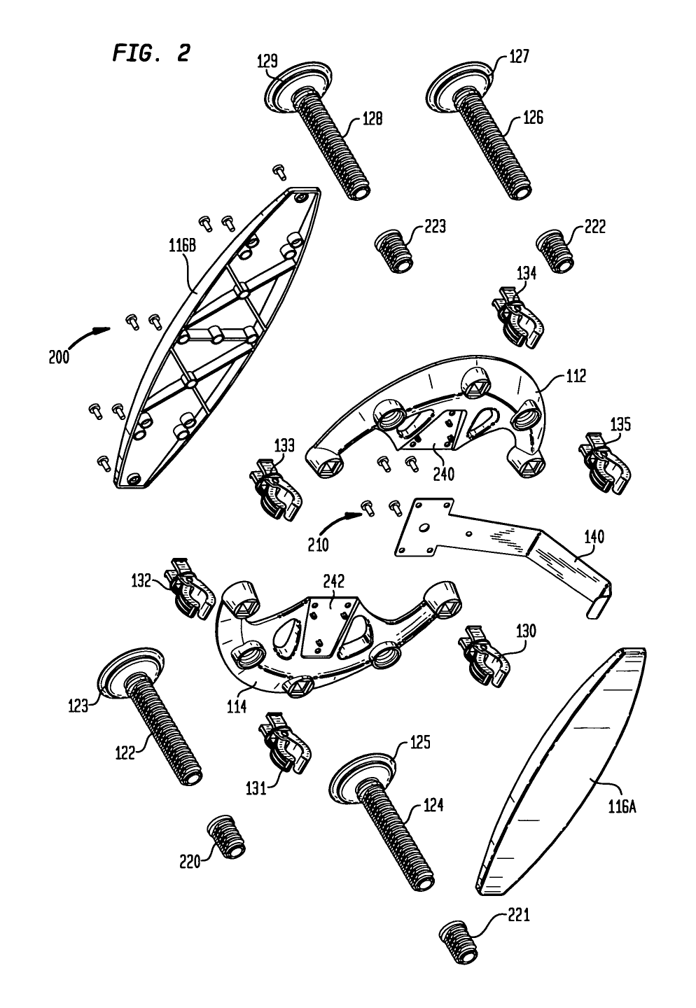

FIG. 2 is an exploded view of the exemplary sports equipment rack 100 of FIG. 1. Sports equipment rack 100 includes two arcuate members 112, 114, and clips 130, 131, 132, 133, 134, 135 having tabs for inserting into appropriately sized holes in arcuate members 112, 114. Cross-member 116 is shown in FIG. 2 split into first cross-member part 116a and second cross-member part 116b. Screws 200 may attach first cross-member part 116a and second cross-member part 116b to form cross-member 116. Additionally, screws 200 may attach cross-member 116 to arcuate members 112, 114. In particular, arcuate members 112, 114 may include platelike surface areas 240, 242, respectively. Platelike surface areas 240, 242, may be in an interior area of the respective arcs of arcuate members 112, 114, and may be sandwiched by first cross-member part 116a and second cross-member part 116b. Screws 200 may pass through platelike surface areas 240, 242, thereby attaching cross-member 116 and arcuate members 112, 114.

Hook 140 may attach to one of first cross-member part 116a and second cross-member part 116b by screws 210, and in particular may attach to a part of first cross-member part 116a or second cross-member part 116b that is covered by the other cross-member part when sports equipment rack 100 is assembled. Hook 140 may extend out from a seam or gap between first cross-member part 116a and second cross-member part 116b when sports equipment rack 100 is assembled.

Legs 122, 124, 126, 128 are shown with suction cups 123, 125, 127, 129, respectively, attached. Leg mounts 220, 221, 222, 223 are detached from but associated with legs 122, 124, 126, 128, respectively. Leg mounts 220, 221 attach to arcuate member 114, and leg mounts 222, 223 attach to arcuate member 112. Leg mounts 220, 221, 222, 223 may attach to their respective arcuate member by cooperating screw threads, or by any other appropriate reversible or non-reversible arrangement, including, for example, a snap lock mechanism. Legs 122, 124, 126, 128 may attach to their respective leg mounts by cooperating screw threads, or by any other appropriate reversible or non-reversible arrangement, including, for example, a snap lock mechanism. As discussed previously, different size legs may be used in sports equipment rack 100, or no legs may be used and the suction cups may be attached directly to the arcuate members, or directly to the leg mounts. In still further alternatives, suction cups may be replaced by mounting brackets having screw or nail holes, hooks, or rubber caps.

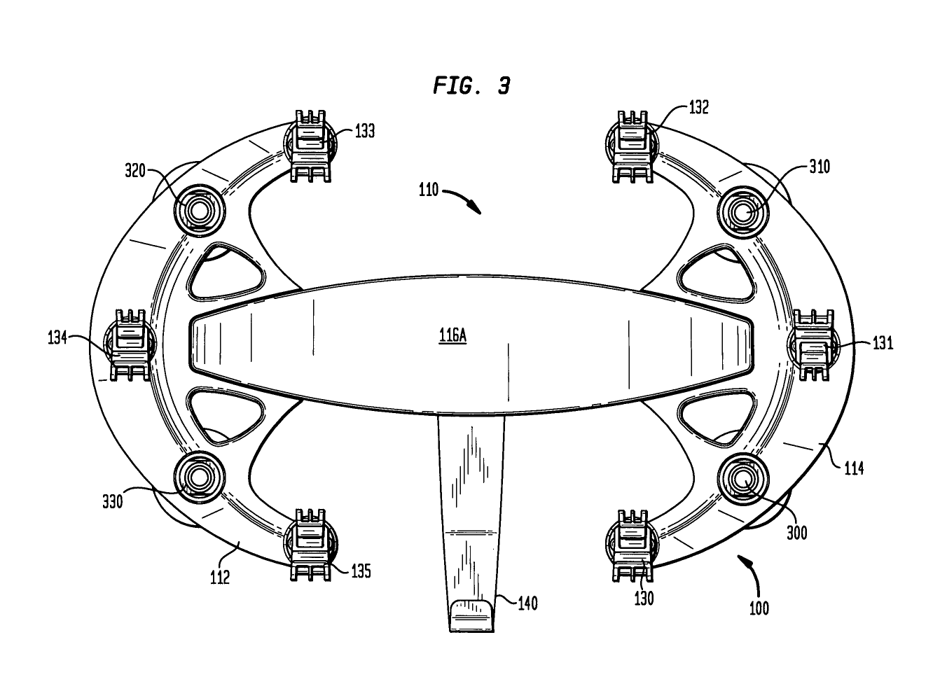

FIG. 3 is a plan view of sports equipment rack 100. FIG. 3 shows frame 110 including arcuate members 112, 114 connected by first cross-member part 116a. First cross-member part 116a is attached to a center-point on each arcuate member 112, 114. Each arcuate member 112, 114 has three clips 133, 134, 135, and 130, 131, 132, respectively. Hook 140 may extend out from first cross-member part 116a. Arcuate member 112 may have mounting holes 320, 330 through which leg mounts, legs, suction cups, or other mounting arrangements may be attached. Arcuate member 114 may have mounting holes 300, 310 through which leg mounts, legs, suction cups, or other mounting arrangements may be attached.

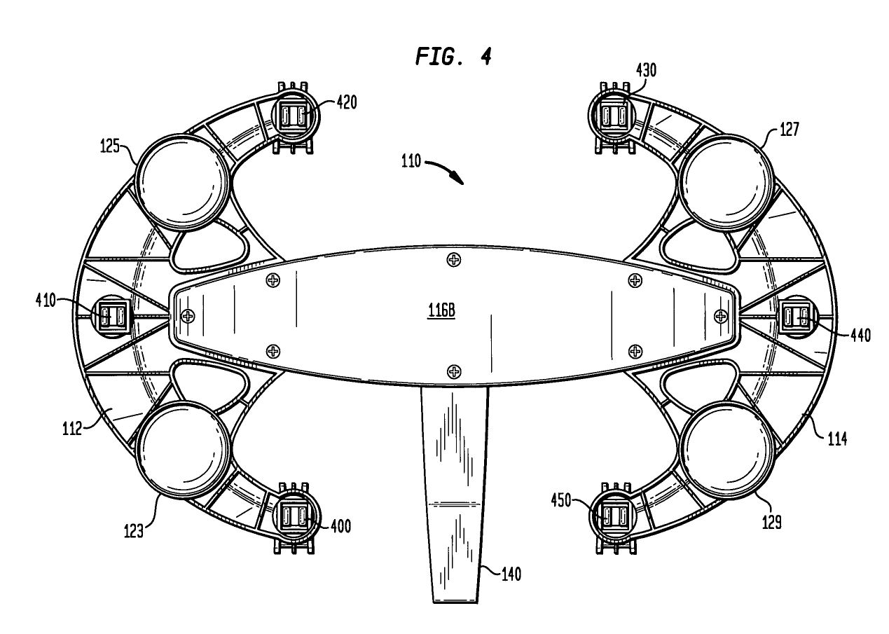

FIG. 4 is a bottom view of sports equipment rack 100. FIG. 4 shows frame 110 including arcuate members 112, 114 connected by second cross-member part 116b. Second cross-member part 116b is attached to a center-point on each arcuate member 112, 114. Each arcuate member 112, 114 has two associated suction cups 123, 125 and 127, 129 respectively, Hook 140 may extend out from second cross-member part 116b. Arcuate member 112 may have clip mounts 400, 410, and 420 through which clips or other releasable retaining arrangements may be attached. Arcuate member 114 may have clip mounts 430, 440, and 450 through which clips or other releasable retaining arrangements may be attached.

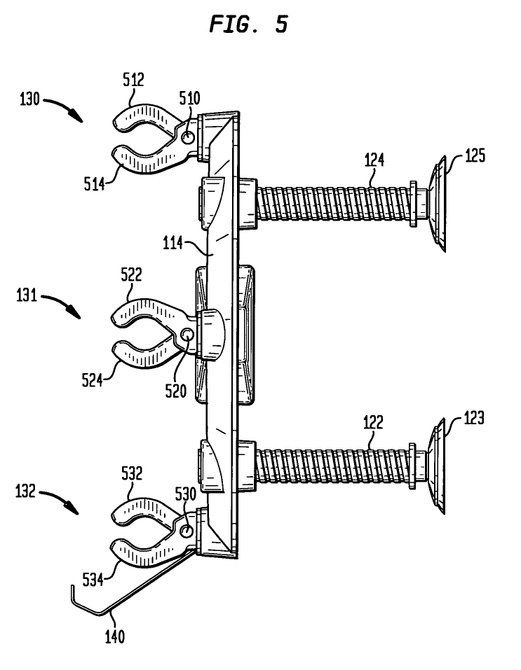

FIG. 5 is an end view of sports equipment rack 100. FIG. 5 shows arcuate member 114, hook 140 and legs 122, 124 with respective suction cups 123, 125. Also shown in FIG. 5 are clips 130, 131, 132. Each clip includes several sub-parts. For instance, clip 130 includes hinge 510, and clip arms 512 and 514. Clip arms 512 and 514 may be motivated by a spring acting in or around hinge 510 to close, and may thereby open to allow the insertion of a shaft of a sport stick or other elongated article. After inserting the elongated article, clip arms 512 and 514 may be closed by the spring with a force sufficient to hold the elongated article in a friction grip. Clip 131 may include hinge 520, and clip arms 522 and 524, which may also be motivated by a spring acting in or around hinge 520 to close. Clip 132 may include hinge 530, and clip arms 532 and 534, which may also be motivated by a spring acting in or around hinge 530 to close.

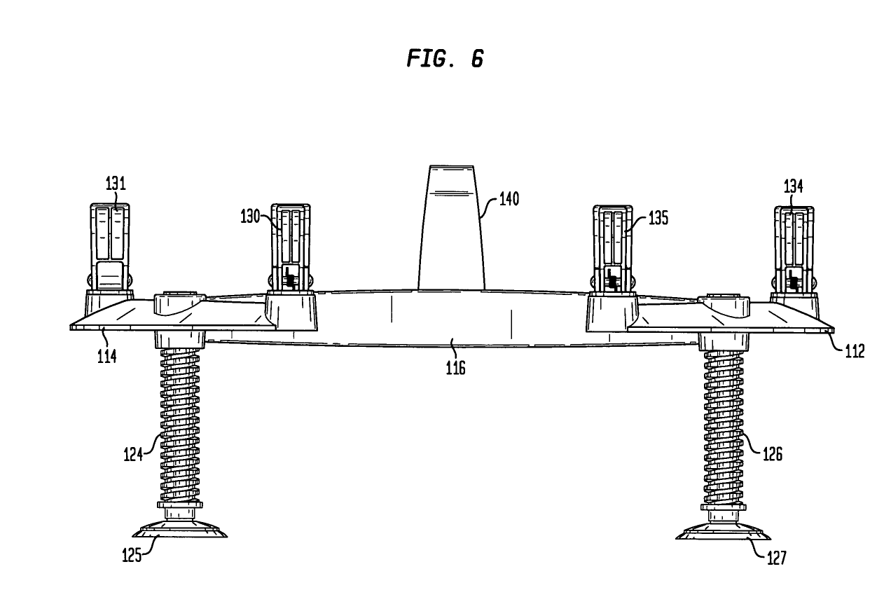

FIG. 6 is an end view of sports equipment rack 100. FIG. 6 shows arcuate members 112, 114, hook 140 connected to cross-member 116, and legs 124, 126 with respective suction cups 125, 127. Also shown in FIG. 6 are clips 130, 131, 134, 135, shown in an edge-on orientation. As discussed earlier, clips 130, 131, 134, 135 may be rotatable.

It is to be understood that the embodiments shown and described herein are only illustrative of the principles of the present invention and that various modifications may be implemented by those skilled in the art without departing from the scope and spirit of the invention.

I claim:

1. A device for retaining an elongated article comprising:
two oppositely oriented arcuate members;
a member extending between and connecting said arcuate members;
means mounted on each of said arcuate members for releasably engaging the article; and
means associated with said arcuate members for mounting same on a surface.

2. The device of claim 1, wherein the elongated article comprises at least one of a lacrosse stick, a hockey stick, baseball bat, golf club and a field hockey stick.

3. The device of claim 1, wherein concave edges of the two oppositely oriented arcuate members face each other.

4. The device of claim 3, the member is substantially linear and connects centers of the concave edges.

5. The device of claim 1, wherein the means for releasably engaging the article include spring-loaded clips able to releasably engage the elongated article, each clip being rotatable with respect to the respective arcuate member.

6. The device of claim 1, wherein the means for releasably engaging the article include six clips, three of the clips being mounted on each of the two arcuate members, two of the clips on each arcuate member being mounted near ends of the respective arcuate member and one of the clips on each arcuate member being mounted at a center of the arcuate member.

7. The device of claim 6, wherein the six clips are arranged on the frame to hold three articles, two clips holding each article, the articles being parallel to the member when held by the clips.

8. The device of claim 6, wherein the six clips are arranged on the frame to hold four articles, the two clips mounted near the tip of each respective arcuate member holding one of the four articles, and the one clip mounted at a center of the arc of each respective arcuate member holding one of the four articles, the articles being orthogonal to the member when held by the clips.

9. The device of claim 1, wherein the means for mounting include four suction cups, two of the four suction cups being connected to each arcuate member.

10. The device of claim 9, wherein each suction cup includes a height adjustable leg attaching each suction cup to the respective arcuate member.

11. The device of claim 1, wherein the device is adapted to releasably receive a sign, the sign including indicia promoting at least one of a team, a school, and a sponsor.

12. A retaining device comprising:
a frame including two arcuate members connected by a cross member, each arcuate member being oriented opposite to the other arcuate member;
at least one clip mounted on the frame and adapted to releasably engage an elongated article; and
a mounting arrangement connected to the frame and adapted to attach the frame to a surface.

13. The device of claim 12, wherein the elongated article comprises at least one of a lacrosse stick, a hockey stick, baseball bat, golf club and a field hockey stick.

14. The device of claim 12, wherein concave edges of the two oppositely oriented arcuate members face each other.

15. The device of claim 14, the member is substantially linear and connects centers of the concave edges.

16. The device of claim 12, wherein the clips are spring-loaded to releasably engage the elongated article, and the clips are rotatable with respect to the frame.

17. The device of claim 12, wherein the at least one clip includes six clips, three of the clips being mounted on each of the two arcuate members, two of the clips on each arcuate member being mounted near ends of the respective arcuate member and one of the clips on each arcuate member being mounted at a center of the arcuate member.

18. The device of claim 1, wherein the mounting arrangement includes four suction cups, two of the four suction cups being connected to each arcuate member.

19. The device of claim 18, wherein each suction cup includes a height adjustable leg attaching each suction cup to the respective arcuate member.

20. The device of claim 1, wherein the device is adapted to releasably receive a sign, the sign including indicia promoting at least one of a team, a school, and a sponsor.
